(19) United States
(12) Patent Application Publication
(10) Pub. No.: US 2022/0291434 A1
(43) Pub. Date: Sep. 15, 2022

(54) Wire Grid Polarizer Wire Sidewall Protection

(71) Applicant: Moxtek, Inc., Orem, UT (US)

(72) Inventors: Bob West, Orem, UT (US); R. Stewart Nielson, Pleasant Grove, UT (US)

(21) Appl. No.: 17/671,274

(22) Filed: Feb. 14, 2022

Related U.S. Application Data
(60) Provisional application No. 63/160,047, filed on Mar. 12, 2021.

(51) Int. Cl. G02B 5/30; G02B 1/14

(52) U.S. Cl. CPC G02B 5/3058; G02B 1/14

(57) ABSTRACT

A wire grid polarizer can have a protective-layer PL on each wire 12 sidewall SW. The protective-layer PL can protect the sidewall SW from corrosion, oxidation, or both. The protective-layer PL can be absent from or thinner at a distal-end DE of the wire 12, farther from the substrate. Polarizer performance degradation, from the protective-layer PL, can be minimized or eliminated by removing the protective-layer PL from the distal-end DE. The invention is particularly applicable to a wire grid polarizer with multiple layers UL and LL, and the upper-layer UL at the distal-end DE is more resistant to corrosion and oxidation than the embedded lower-layer LL.

### CLAIM OF PRIORITY

This application claims priority to US Provisional Patent Application Number US 63/160,047, filed on Mar. 12, 2021, which is incorporated herein by reference.

### FIELD OF THE INVENTION

The present application is related to wire grid polarizers.

### BACKGROUND

A wire grid polarizer can divide light into two different polarization states. One polarization state can primarily pass through the wire grid polarizer. The other polarization state can be primarily absorbed or reflected. The effectiveness or performance of wire grid polarizers is based on (a) high transmission of a predominantly transmitted polarization (sometimes called Tp) and (b) minimal transmission of an opposite polarization (sometimes called Ts).

It can be beneficial to have high contrast (Tp/Ts). Contrast can be improved by increasing transmission of the predominantly transmitted polarization (e.g. increasing Tp) and by decreasing, transmission of the opposite polarization (e.g. decreasing Ts).

If the reflected light beam will be used, it can be helpful to have high reflectance of the opposite polarization (e.g. high Rs). For a reflective wire grid polarizer, efficiency (Tp*Rs) is a useful indicator of wire grid polarizer performance. If the reflected light beam is not used, and if reflected light will interfere with the optical system, it can be helpful to have low reflectance of the opposite polarization (e.g. low Rs). Thus, the percent reflection of the opposite polarization (Rs) can also be a useful indicator of polarizer performance.

### BRIEF DESCRIPTION OF THE DRAWINGS (DRAWINGS MIGHT NOT BE DRAWN TO SCALE)

FIG. 1 is a cross-sectional side-view of a wire grid polarizer 10 with wires 12 on a substrate 11. Each wire 12 can have a lower-layer LL and an upper-layer UL. A protective-layer PL can be on each wire 12 sidewall SW.

FIG. 2 is a cross-sectional side-view of a wire grid polarizer 20 with wires 12 on a substrate 11. A protective-layer PL can be on each wire 12 sidewall SW. A hydrophobic-layer HL can be on distal-ends DE of the wires 12.

FIG. 3 is a cross-sectional side-view of a wire grid polarizer 30 with wires 12 on a substrate 11. A protective-layer PL can be on each wire 12 sidewall SW. A hydrophobic-layer HL can be a conformal layer on the wires 12. The protective-layers PL can be sandwiched between the hydrophobic-layer HL and the wire 12.

FIG. 4 is a cross-sectional side-view of a wire grid polarizer 40 with wires 12 on a substrate 11. A protective-layer PL is thicker on the wire 12 sidewall SW than (a) on the substrate 11 in the channels 13 and (b) on the distal-end DE (TP>TS and TP>TD).

FIG. 5 is a cross-sectional side-view of step 50 in a method of making a wire grid polarizer, including applying a protective chemical 51 in a conformal layer on the wires 12.

Definitions. The following definitions, including plurals of the same, apply throughout this patent application.

As used herein, the term “conformal layer” means a continuous thin film that conforms to the contours of feature topology. For example, a minimum thickness across the entire conformal layer can be greater than 1 nm and a maximum thickness across the entire conformal layer can be ≤20 nm. As another example, a maximum thickness across the entire conformal layer divided by a minimum thickness across the entire conformal layer can be ≤2, ≤3, ≤5, ≤10, or ≤20.

As used herein, the terms “on”, “located on”, “located at”, and “located over” mean located directly on or located over with some other solid material between. The terms “located directly on”, “adjoin”, “adjoins”, and “adjoining” mean direct and immediate contact.

As used herein, the term “nm” means nanometer(s).

### DETAILED DESCRIPTION

Ribs or wires of wire grid polarizers, especially for polarization of visible or ultraviolet light, can be small and delicate with nanometer-sized pitch, wire-width, and wire-height. Wire grid polarizers are used in systems (e.g. computer projectors, semiconductor inspection tools, etc.) that require high performance. Corroded wires can degrade system performance. Wire oxidation can reduce contrast. Therefore, it can be useful to protect the wires from corrosion and oxidation.

Wire grid polarizers have traditionally been made with a protective chemical in a conformal layer. See for example patents U.S. Pat. Nos. 6,785,050, 9,995,864, and 10,054,717. However, material of the protective chemical can degrade polarizer performance. Wire grid polarizer manufacturers have reluctantly accepted this reduced performance because of a greater need to protect the wires from corrosion and oxidation. Thus, there has been a tradeoff between higher performance and protection of the wires.

The present invention provides wire grid polarizers 10, 20, 30, and 40, and methods of making wire grid polarizers, without this tradeoff. Thus, the present invention provides protection for wires 12 of wire grid polarizers 10, 20, 30, and 40 without any, or with less, performance degradation.

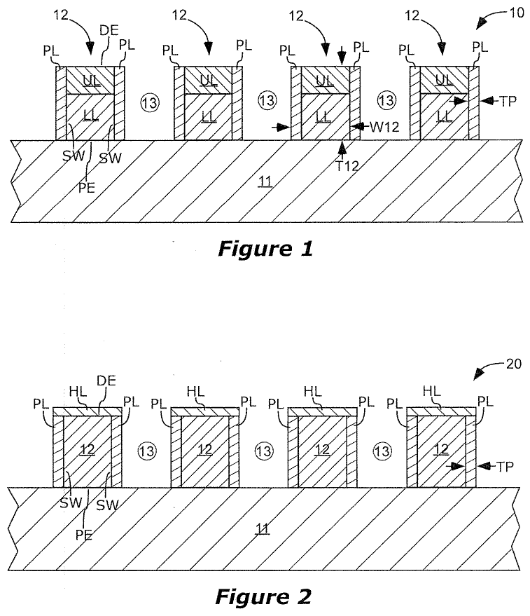

As illustrated in FIGS. 1-4, wire grid polarizers 10, 20, 30, and 40 are shown comprising wires 12 on a substrate 11. The wires 12 and the channels 13 can alternate, with a channel 13 between each pair of adjacent wires 12. The channels 13 can be filled with air or other gas, vacuum, liquid, solid, or combinations thereof. Any solid in the channels 13 can be transparent.

Each wire 12 can have a proximal-end PE closer to the substrate 11, a distal-end DE farther from the substrate 11, and a sidewall SW on each of two opposite sides of each wire 12. Each sidewall SW can extend from the proximal-end PE to the distal-end DE. Each sidewall SW can face a channel 13.

The wire grid polarizers 10, 20, 30, and 40 can include protective-layers PL to protect the wires 12 from corrosion, oxidation, or both. Material of the protective-layers PL at the distal-end DE can degrade polarizer performance. The protective-layers PL can be mostly or solely on sidewalls SW of the wires 12. The protective-layers PL on sidewalls SW does not cause performance degradation like protective material on the distal-end DE. But the protective-layers PL on sidewalls SW do protect the wires 12.

A protective-layer PL can be located on each sidewall SW. Each protective-layer PL can adjoin the sidewall SW of the wire 12. The wire 12 can be sandwiched between a pair of the protective-layers PL.

Each protective-layer PL can have a minimum thickness TP of at least 0.1 nm, 0.5 nm, or 1 nm. A thicker protective-layer PL provides better corrosion and oxidation protection. Each protective-layer PL can have a maximum thickness TP of less than or equal to 4 nm, 5 nm, 10 nm, or 20 nm on the sidewall SW. A thicker protective-layer PL is more expensive. The thickness TP is measured perpendicular to the sidewall SW at the location of measurement.

The pair of protective-layers PL can be separated from each other by a region on the distal-end DE that is free of the protective-layer PL. The distal-end DE can be free of the protective-layer PL.

A region on the substrate 11 in the channel 13 can be free of the protective-layer PL. The substrate 11 in the channel 13 can be free of the protective-layer PL. Thus, each protective-layer PL can be separate from the protective-layer PL on an adjacent wire 12.

Alternatively, as illustrated in FIG. 4, there can be some of the protective-layer PL on the substrate 11 in the channels 13 and on the distal-end DE, but thinner in these regions than on the sidewalls SW. For oxidation and corrosion protection, wire grid polarizer 40 is preferred; but wire grid polarizers 10, 20, and 30 are preferred for wire grid polarizer performance.

For example, a thickness TP of the protective-layer PL on the sidewalls SW can be at least 5 times greater, 25 times greater, or 100 times greater than a maximum thickness TS of the protective-layer PL on the substrate 11 in the channels 13. As another example, a thickness TP of the protective-layer PL on the sidewalls SW can be at least 5 times greater, 25 times greater, or 100 times greater than a maximum thickness TD of the protective-layer PL on the distal-end DE. The protective-layer PL of wire grid polarizer 40 can be combined with the features of any other wire grid polarizer described herein, including the wire grid polarizers in FIGS. 1-3 and 5.

The protective-layers PL are particularly useful for a wire grid polarizer with a multi-layer stack, and with a layer needing protection that is lower in the stack. For example, each wire 12 of wire grid polarizer 10 can include a lower-layer LL closer to the proximal-end PE and an upper-layer UL closer to the distal-end DE. The substrate 11, the pair of protective-layers PL, and the upper-layer UL can encircle the lower-layer LL. The upper-layer UL can be more resistant to corrosion in water, more resistant to oxidation, or both than the lower-layer LL. The upper-layer UL can be exposed to air and water, but is protected because it is more inert than the lower-layer LL.

An example material for the upper-layer UL is silicon. Example materials for the lower-layer LL include germanium, aluminum, or both.

The lower-layer LL and the upper-layer UL of wire grid polarizer 10 can be combined with the features of any other wire grid polarizer described herein, including the wire grid polarizers in FIGS. 2-5.

The protective-layer PL can include material(s) to protect the wires 12 from oxidation, corrosion, or both. For example, the protective-layer PL can include an amino phosphonate, a metal oxide, a metalloid oxide, or combinations thereof. The protective-layer PL can include a transition metal oxide. The protective-layer PL can include a post-transition metal oxide.

The protective-layer PL can include an actinide oxide. The protective-layer PL can include rare earth oxide(s), such as for example, oxides of scandium, yttrium, lanthanum, cerium, praseodymium, neodymium, promethium, samarium, europium, gadolinium, terbium, dysprosium, holmium, erbium, thulium, ytterbium, lutetium, or combinations thereof.

The protective-layer PL can include aluminum oxide, silicon oxide, silicon nitride, silicon oxynitride, silicon carbide, hafnium oxide, zirconium oxide, or combinations thereof.

The protective-layer PL can include an oxygen-barrier and a moisture-barrier. The oxygen-barrier can be sandwiched between the moisture-barrier and the sidewall SW. The oxygen-barrier can include aluminum oxide, silicon oxide, silicon nitride, silicon oxynitride, silicon carbide, or combinations thereof. The oxygen-barrier can protect the wire 12 from oxidation. The moisture-barrier can include hafnium oxide, zirconium oxide, or combinations thereof. The moisture-barrier can protect the wire 12 from corrosion.

The protective-layer PL can be distinct from the sidewall SW, meaning (1) there can be a boundary line or layer between the sidewall SW and the protective-layer PL; or (2) there can be some difference of material of the sidewall SW relative to a material of the protective-layer PL. For example, a native aluminum oxide can form at the sidewall SW of an aluminum wire 12. A layer of aluminum oxide (protective-layer PL) can then be applied on the wires 12 as the oxygen-barrier.

This added layer of aluminum oxide can be useful, because a thickness and density of the native aluminum oxide can be insufficient for protecting a core of the wires 12 from oxidizing. In this example, although the protective-layer PL (Al₂O₃) might have the same chemical formula as a surface (Al₂O₃) of the wires 12, the protective-layer PL can still be distinct due to (1) a boundary layer between the protective-layer PL and the wires 12 and/or (2) a difference in material properties (e.g. increased density of the protective-layer PL).

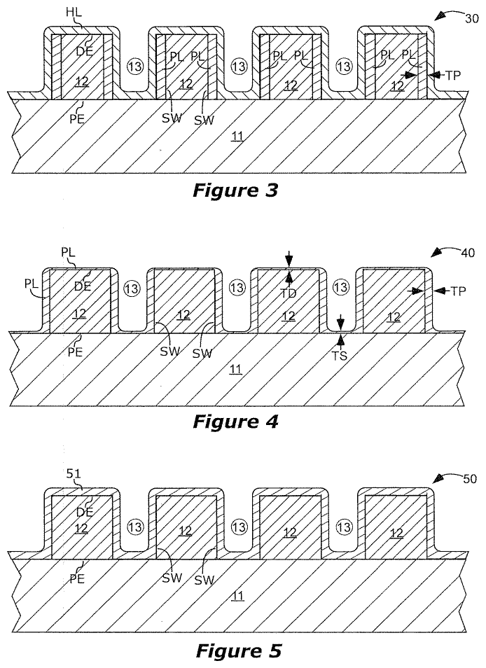

As illustrated in FIGS. 2-3, wire grid polarizers 20 and 30 can also have a hydrophobic-layer HL on the distal-ends DE of the wires 12. The hydrophobic-layer HL can adjoin the distal-ends DE of the wires 12. The hydrophobic-layer HL can prevent water from entering the channels 13. The hydrophobic-layer HL can be only on the distal-ends DE of the wires 12, as illustrated in FIG. 2. It is preferable, however, for the hydrophobic-layer HL to be a conformal layer as illustrated in FIG. 3. Thus, each protective-layer PL can be sandwiched between the hydrophobic-layer HL and the wire 12.

Example chemistry of the hydrophobic-layer HL includes chemical formula (1), chemical formula (2), or both:

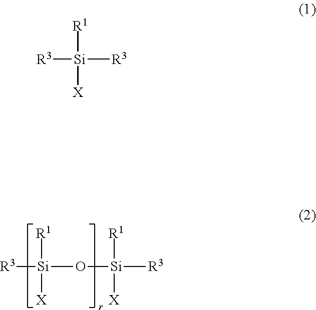

where r is a positive integer, each R¹ independently is a hydrophobic group, X is a bond to the ribs, and each R³ is independently a chemical element or a group.

Each R³ can be a silane-reactive-group, —H, R¹, R⁶, or X. Each silane-reactive-group can be —Cl, —OR⁶, —OCOR⁶, —N(R⁶)₂, or —OH. Each R⁶ can be an alkyl group, an aryl group, or combinations thereof.

Each hydrophobic group can include Cf₃(CF₂)ₙ or CF₃(CF₂)ₙ(CH₂)ₘ. n and m are integers. Example lower boundaries for n include 1≤n, 2≤n, or 3≤n. Example upper boundaries for n include n≤3, n≤4, n≤5, n≤6, n≤8, or n≤20. Example lower boundaries for m include 1≤m or 2≤m. Example upper boundaries for in include m≤2, m≤3, m≤4, m≤5, m≤8, or m≤20.

The hydrophobic-layer HL of wire grid polarizers 20 or 30 can be combined with the features of any other wire grid polarizer described herein, including the wire grid polarizers in FIGS. 1 and 4-5.

For all wire grid polarizers described herein, the wires 12 can be parallel and elongated. As used herein, the term “elongated” means that wire 12 length (into the sheet of the figures) is substantially greater than wire width W₁₂ and wire thickness T12 (see FIG. 1). For example, wire length can be ≥10 times, ≥100 times, ≥1000 times, or ≥10,000 times larger than wire width W12, wire thickness T12, or both. A pitch of the wires 12 can be less than ½ of a lowest wavelength of a desired range of polarization. All wires 12 can have the same thickness T12, the same width W12, the same length, or combinations thereof with respect to each other.

As an alternative to the wire grid polarizer of the prior paragraph, the wires can extend in multiple different directions, can have multiple different thicknesses T12, can have multiple different widths W₁₂, can have multiple different lengths, or combinations thereof. The wire grid polarizers described herein can be metamaterial polarizers.

### Method

A method of making a wire grid polarizer can include some or all of the following steps. These steps can be performed in the following order or other order if so specified. The wire grid polarizer, and components of the wire grid polarizer, can have properties as described above. Any additional description of properties of the wire grid polarizer in the method below, not described above, are applicable to the above described wire grid polarizers.

Steps in the method include—
(A) applying a protective chemical 51 in a conformal layer on wires 12 (see FIG. 5);
(B) etching the protective chemical 51 anisotropically to form a protective-layer PL on each sidewall SW of each wire (see FIGS. 1 and 4); and
(C) applying a hydrophobic-layer HL on the distal-end DE of the wires 12, on the pair of protective-layers PL, or both (see FIGS. 2-3).

In step (A), the wires 12 can be on a substrate 11. Each wire 12 can have a proximal-end PE closer to the substrate 11, a distal-end DE farther from the substrate 11, and a sidewall SW on each of two opposite sides. Each sidewall SW can face a channel 13 and can extend from the proximal-end PE to the distal-end DE.

Step (B) can include etching the protective chemical 51 anisotropically to remove the protective chemical 51 from the distal-end DE of each wire 12 and leaving the protective chemical 51 as a protective-layer PL on each sidewall SW.

Step (B) can include etching the protective chemical 51 anisotropically to remove the protective chemical 51 from the substrate 11 in the channels 13 and leaving the protective chemical 51 as a protective-layer PL on each sidewall SW.

Note that due to the direction of the anisotropic etch, it can remove most or all of the protective chemical 51 from the distal-end DE and from the substrate 11 in the channels 13, but leave the protective chemical 51 as a protective-layer PL on each sidewall SW.

Step (B) can include applying the protective chemical 51 by atomic layer deposition. Step (C) can include applying the hydrophobic-layer HL by chemical vapor deposition.

What is claimed is:

1. A wire grid polarizer comprising:
wires on a substrate with channels between adjacent wires, each wire having a proximal-end closer to the substrate and a distal-end farther from the substrate;
a sidewall on each of two opposite sides of each wire, each sidewall facing a channel and extending from the proximal-end to the distal-end;
a protective-layer on each sidewall with the wire sandwiched between a pair of the protective-layers;
the pair of the protective-layers are separate from each other by a region on the distal-end that is free of the protective-layer;
the protective-layer includes a metal oxide, an amino phosphonate, or both;
each protective-layer has a maximum thickness of 25 nm, the thickness measured perpendicular to the sidewall at the location of measurement;
each wire has multiple layers including a lower-layer closer to the proximal-end and an upper-layer closer to the distal-end;
the upper-layer is more resistant than the lower-layer to corrosion in water, oxidation, or both; and
the substrate, the pair of protective-layers, and the upper-layer encircle the lower-layer.

2. A wire grid polarizer comprising:
wires on a substrate with channels between adjacent wires, each wire having a proximal-end closer to the substrate and a distal-end farther from the substrate;
a sidewall on each of two opposite sides of each wire, each sidewall facing a channel and extending from the proximal-end to the distal-end;
a protective-layer on each sidewall with the wire sandwiched between a pair of the protective-layers;
the pair of the protective-layers are separate from each other by a region on the distal-end that is free of the protective-layer; and
each protective-layer includes an amino phosphonate, a metal oxide, or both.

3. The wire grid polarizer of claim 2, wherein each protective-layer adjoins a respective sidewall of the wire.

4. The wire grid polarizer of claim 2, wherein:
each wire has multiple layers including a lower-layer closer to the proximal-end and an upper-layer closer to the distal-end; and
the upper-layer is more resistant to corrosion in water than the lower-layer.

5. The wire grid polarizer of claim 2, wherein:
each wire has multiple layers including a lower-layer closer to the proximal-end and an upper-layer closer to the distal-end; and
the upper-layer is more resistant to oxidation than the lower-layer.

6. The wire grid polarizer of claim 2, wherein:
each wire has multiple layers including a lower-layer closer to the proximal-end and an upper-layer closer to the distal-end;
the lower-layer includes germanium, aluminum, or both; and
the substrate, the pair of protective-layers, and the upper-layer encircle the lower-layer.

7. The wire grid polarizer of claim 2, wherein the distal-end of each wire is free of the protective-layer.

8. The wire grid polarizer of claim 2, wherein:
each wire has multiple layers including a lower-layer closer to the proximal-end and an upper-layer closer to the distal-end; and
the upper-layer includes silicon and the lower-layer includes germanium, aluminum, or both.

9. The wire grid polarizer of claim 2, wherein the substrate in the channel is free of the protective-layer.

10. The wire grid polarizer of claim 2, wherein each protective-layer includes aluminum oxide, silicon oxide, silicon nitride, silicon oxynitride, silicon carbide, hafnium oxide, zirconium oxide, or combinations thereof.

11. The wire grid polarizer of claim 2, further comprising:
each protective-layer includes an oxygen-barrier and a moisture-barrier;
the oxygen-barrier sandwiched between the moisture-barrier and the sidewall;
the oxygen-barrier is distinct from the sidewall;
the oxygen-barrier includes aluminum oxide, silicon oxide, silicon nitride, silicon oxynitride, silicon carbide, or combinations thereof; and
the moisture-barrier includes hafnium oxide, zirconium oxide, or combinations thereof.

12. The wire grid polarizer of claim 2, wherein the protective-layer includes amino phosphonate.

13. The wire grid polarizer of claim 2, wherein the protective-layer includes a metal oxide.

14. The wire grid polarizer of claim 2, further comprising a hydrophobic-layer on the distal-ends of the wires, the hydrophobic-layer including chemical formula (1), chemical formula (2), or combinations thereof: 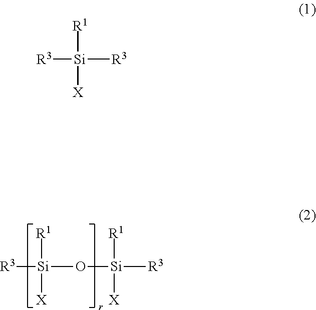
where r is a positive integer, each R¹ independently is a hydrophobic group, X is a bond to the ribs, and each R³ is independently a chemical element or a group.

15. The wire grid polarizer of claim 14, wherein:
each R³ is independently selected from the group consisting of: a silane-reactive-group, —H, R¹, R⁶, X, and combinations thereof;
each silane-reactive-group is independently selected from the group consisting of: —Cl, —OR⁶, —OCOR⁶, —N(R⁶)₂, —OH, and combinations thereof; and
each R⁶ is independently an alkyl group, an aryl group, or combinations thereof.

16. The wire grid polarizer of claim 14, wherein each hydrophobic group is independently CF₃(CF₂)ₙ(CH₂)ₘ, where n and m are integers within the boundaries of: 1≤n≤4 and 1≤m≤5.

17. The wire grid polarizer of claim 14, wherein each hydrophobic group is independently CF₃(CF₂)ₙ, where n is an integer within the boundaries of: 1≤n≤3.

18. The wire grid polarizer of claim 14, wherein the hydrophobic-layer is a conformal layer and each protective-layer is sandwiched between the hydrophobic-layer and the wire.

19. A wire grid polarizer comprising:
wires on a substrate with channels between adjacent wires, each wire having a proximal-end closer to the substrate and a distal-end farther from the substrate;
a sidewall on each of two opposite sides of each wire, each sidewall facing a channel and extending from the proximal-end to the distal-end;
a protective-layer on each sidewall with the wire sandwiched between a pair of the protective-layers;
the pair of the protective-layers are separate from each other by a region on the distal-end that is free of the protective-layer;
each protective-layer is separate from the protective-layer on an adjacent wire by a region on the substrate in the channel that is free of the protective-layer; and
each protective-layer has a thickness of less than or equal to 10 nm, the thickness measured perpendicular to the sidewall at the location of measurement.

20. The wire grid polarizer of claim 19, further comprising a hydrophobic-layer that is a conformal layer on the distal-ends of the wires and on the protective-layers, and each protective-layer is sandwiched between the hydrophobic-layer and the wire.
